(19) United States
(12) Patent Application Publication
(10) Pub. No.: US 2008/0179203 A1
(43) Pub. Date: Jul. 31, 2008

(54) Tool Box with Integrated Work Bench

(76) Inventor: Frederick H. Mueller, San Angelo, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/668,990

(22) Filed: Jan. 30, 2007

(51) Int. Cl. B25H 3/02

(52) U.S. Cl. 206/216

(57) ABSTRACT

A tool box includes an integrated work bench. The tool box comprises a base and a pair of side walls extending upwardly from the base. Each of the side walls has a rear vertical edge, an upper horizontal edge, a front vertical edge, and a slanted edge sloping downwardly from the upper horizontal edge to the front vertical edge. A rear wall extends upwardly between the side walls and has an upper horizontal edge. An upper cover is pivotally connected by hinges at a location adjacent to the upper section of the rear wall to pivotally swing open upwardly. The upper cover has a horizontal section and a slanted section sloping downwardly from the horizontal section. A lower cover is pivotally connected by hinges at a location adjacent to the forward edge of the base. The lower cover is configured to pivotally swing open downwardly to remain at a horizontal position to form the integrated work bench. The lower cover has an upwardly turned flange along its forward and side edges to prevent tools from sliding off of the work bench.

### FIELD OF THE INVENTION

The invention relates generally to toot boxes. More specifically, the invention relates to a tool box with an integrated work bench.

### BACKGROUND OF THE INVENTION

Toot boxes are used by craftsmen to store and transport tools. Most tool boxes feature one or more compartments for organizing the tools in designated areas in the tool box. Some tool boxes include pegs for retaining nuts, washers and other components in place. Other tool boxes include apertures for retaining certain types of tools, while others provide holes having different diameters for accommodating bolts, while yet others offer a combination of the foregoing features. Although existing tool boxes allow a craftsman to organize the tools in designated areas, during transportation and movement of the tool boxes, the parts often become displaced in the tool boxes. As will be appreciated, when the parts scatter throughout the tool box, it is often difficult to find the particular parts needed for a specific job, thus requiring a craftsman to unnecessarly spend time locating the displaced tools.

Furthermore, at remote work locations, there may not be a convenient workbench available to set out the tools during work. Consequently, during the job a craftsman may have to set out the tools on the ground, which may be inconvenient.

Accordingly, a tool box is needed which provides a solution to the foregoing problems.

### SUMMARY OF THE INVENTION

A tool box with an integrated work bench is disclosed. The tool box comprises a base and a pair of side walls. The side walls extend upwardly from the base. Each of the side walls has a rear vertical edge, an upper horizontal edge, a front vertical edge, and a slanted edge. The slanted edge slopes downwardly from the upper horizontal edge to the front vertical edge. A rear wall extends upwardly between the side walls and has an upper horizontal edge.

An upper cover is pivotally connected by hinges at a location adjacent to the upper section of the rear wall. The upper cover pivotally swings open upwardly. The upper cover has a horizontal section and a slanted section sloping downwardly from the horizontal section. A lower cover is pivotally connected by hinges at a location adjacent to the forward edge of the base. The lower cover is configured to pivotally swing open downwardly and remain at a substantially horizontal position to form the integrated work bench. Thus, the lower cover has a range of movement from a closed position to a substantially horizontal position. The lower cover has an upwardly turned flange along its forward and side edges to prevent tools from sliding off of the work bench.

The tool box includes one or more partition plates extending between the side walls thus defining one or more shelves inside the tool box. A plurality of apertures are formed on the partition plates for retaining the tools. At least one rotating partition plate extends between the side walls. The rotating partition is connected by hinges to the side walls to swing upwardly from a substantially horizontal position. A plurality of upwardly extending pegs are disposed on the rotating partition plate.

### BRIEF DESCRIPTION OF THE DRAWINGS

For a more complete understanding of the features and advantages of the present invention, reference is now made to the detailed description of the invention along with the accompanying figures and in which:

FIGS. 1 and 2 illustrate a perspective view and a side view, respectively, of a tool box in accordance with one embodiment of the invention.

FIG. 3 is a front view of the tool box with the upper and lower covers in open position.

### DETAILED DESCRIPTION OF THE INVENTION

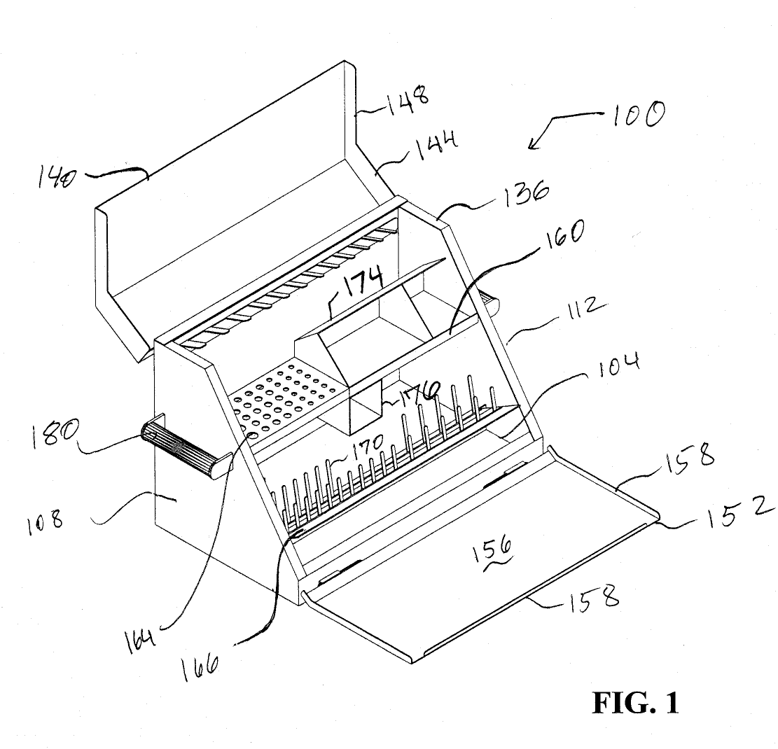

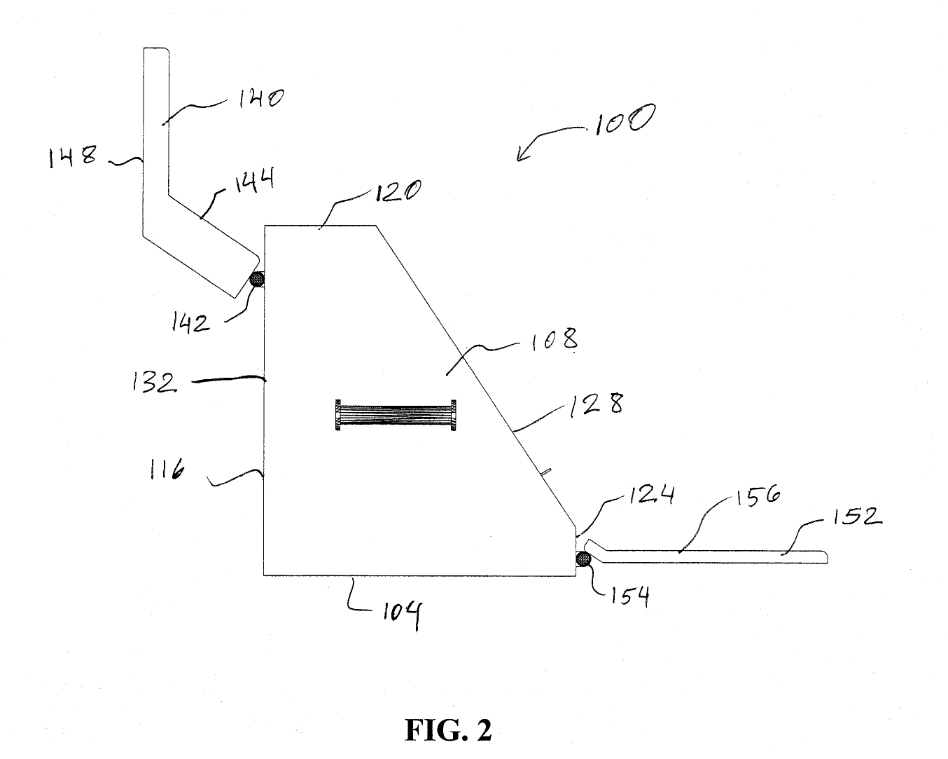

FIGS. 1 and 2 illustrate a perspective view and a side view, respectively, of a tool box 100 constructed in accordance with one embodiment of the invention. The tool box 100 includes a rectangular base 104 preferably made from a sheet metal. The tool box 100 includes a pair of side walls 108 and 112. The side walls 108 and 112 extend upwardly from the base 104. The side walls 108 and 112 each have a rear vertical edge 116, an upper horizontal edge 120, a front vertical edge 124 and a slanted edge 128. The slanted edge 128 slopes downward from the upper horizontal edge 120 to the front vertical edge 124.

The tool box 100 includes a rear wall 132. The rear wall 132 extends upwardly between the side walls 108 and 112. The rear wall has an upper horizontal edge 136.

An upper cover 140 is pivotally connected by hinges 142 at a location adjacent to the upper section of the rear wall 132. The upper cover 140 pivotally swings open upwardly. The upper cover 132 has a horizontal section 144 and a slanted section 148 sloping downwardly from the horizontal section 144.

A lower cover 152 is pivotally connected by hinges 154 at a location adjacent to the forward edge of the base 104. The lower cover 152 pivotally swings open downwardly to remain at a horizontal position to form an integrated work bench 156. The lower cover 152 has an upwardly turned flange 158 along its forward and side edges to prevent tools from sliding off of the work bench 156. The work surface of the work bench 156 may be lined with suitable material to allow a craftsman to work on the work bench 156.

A partition plate 160 extends between the side walls, thereby defining a shelf inside the tool box. It will be apparent that the tool box can be fitted with more than one partition plate to create more shelves. In one embodiment, the partition plate 160 may include rollers that ride on rails built on the side walls 108 and 112 to allow the partition plate 160 to slide forward and rearward.

The tool box 100 includes a plurality of apertures 164 formed on the partition plate 160 for retaining the tools. At least one rotating partition plate 166 extends between the side walls 108 and 112. The rotating partition plate 166 is connected by hinges to the side walls 108 and 112 to swing upwardly from a substantially horizontal position.

The tool box 100 includes a plurality of pegs 170 disposed on the rotating partition plate 166 that extend upwardly. The rotating partition plate 166 extends adjacent to the lower cover 152 when the rotating partition plate 166 is in a substantially horizontal position and the lower cover 152 is in a closed position. The pegs 170 extend substantially adjacent to the lower cover 152 when the rotating partition plate 166 is in a substantially horizontal position and the lower cover 152 is in a closed position such that the tools disposed on the pegs 170 are secured in position by the lower cover 152.

The tool box 100 farther includes one or more upwardly extending compartments 174 having an opening and disposed on the partition plate 166. The opening of the upwardly extending compartments 174 is substantially adjacent to the upper cover 140 when the upper cover 140 is in a closed position so that the tools in the upwardly extending compartments 174 are secured in place.

In another embodiment, the opening of the upwardly extending compartments 174 may be adjacent to the lower cover 152 when the lower cover 152 is in a closed position. In other words, the partition plate 160 which holds the upwardly extending compartments 174 may be close to the base 104 such that the opening of the upwardly extending compartments 174 are adjacent to the lower cover 152.

The tool box 100 includes one or more downwardly extending compartments 176 having an opening and attached to the partition plate 160. The openings of the downwardly extending compartments 176 are substantially adjacent to the upper cover 140 when the upper cover 140 is in a closed position so that the tools in the downwardly extending compartments are secured in place when the tool box is in a closed position

In another embodiment, the openings of the downwardly extending compartments are substantially adjacent to the lower cover 152 when the lower cover 152 is in a closed position. The tool box 100 may include one or more hanging rods each extending between one of the side walls and one of the downwardly extending compartments to hang the tools. Alternately, the tool box may include one or more hanging rods each extending between one of the side wall and the upwardly extending compartment to hang the tools.

As will be apparent, when the tool box 100 is in a closed position the forward edges of the upper and lower covers 140 and 152 engage to close the tool box 100 to secure the tools in place.

The tool box 100 may include a locking mechanism such as a latch disposed on the upper cover 140. The locking mechanism latches the upper cover 148 to the lower cover 152 to lock the tool box 100. Alternately, the locking mechanism may be disposed on the lower cover 152 for latching the lower cover 152 to the upper cover 148 to lock the tool box 100.

In one embodiment, the base 104, the side walls 108 and 112, the rear wall 116 and the covers are made of sheet metal. Other suitable material may be used to make the tool box.

The tool box 100 includes a carrying handle 180 on each side wall for carrying the tool box 100. A carrying handle can also be disposed on the upper cover 148.

As will be apparent, when the tool box 100 is in a closed position, that is both the upper and lower covers 148 and 152 are closed, the tools inside the tool box are secured in their respective areas. Consequently, during transportation or handling of the tool box 100, the tools are not displaced from their respective areas.

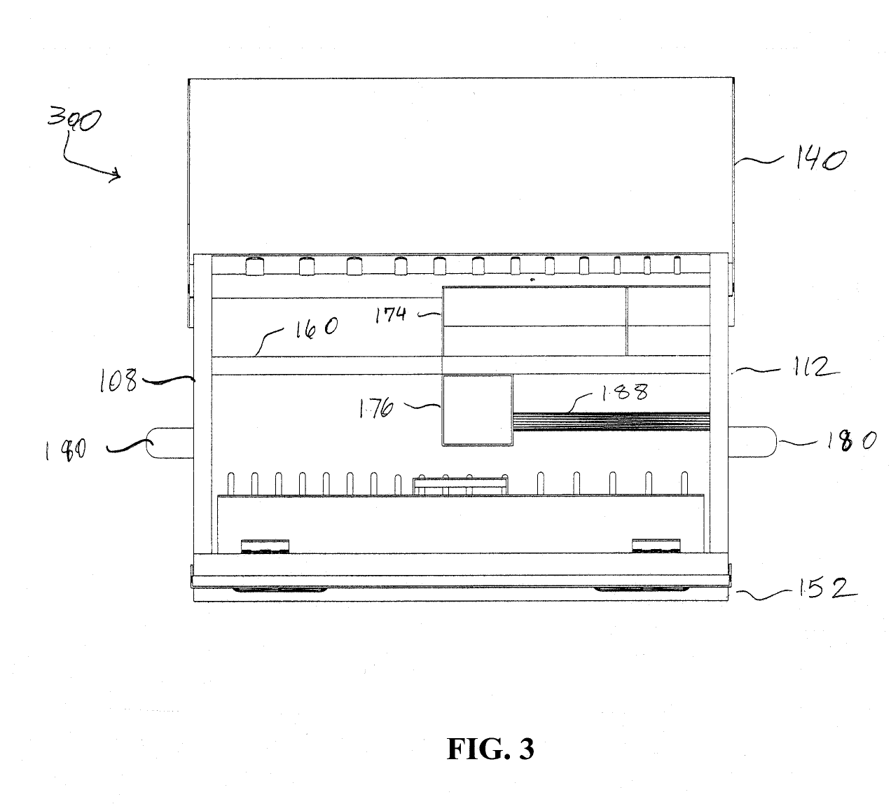

FIG. 3 is a front view of the tool box 300 with the upper and lower covers 140 and 152 in open position. A hanging bar 188 extends between the side wall 112 and the downwardly extending compartment 176.

In one embodiment, suitable liner material may be disposed on the edges of the upper cover, the lower cover, the side walls, the rear wall and the base to seal the tool box. By sealing the tool box, the tools inside can be protected from environmental effects.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A tool box with an integrated work bench comprising:
a base;
a pair of side walls extending upwardly from the base, each of the side walls having a rear vertical edge, an upper horizontal edge, a front vertical edge, and a slanted edge sloping downwardly from the upper horizontal edge to the front vertical edge;
a rear wall extending upwardly between the side walls, the rear wall having an upper horizontal edge;
an upper cover pivotally connected by hinges at a location adjacent to the upper section of the rear wall to pivotally swing open upwardly, the upper cover having a horizontal section and a slanted section sloping downwardly from the horizontal section;
a lower cover pivotally connected by hinges at a location adjacent to the forward edge of the base, the lower cover configured to pivotally swing open downwardly to remain at a horizontal position to form the integrated work bench, the lower cover having an upwardly turned flange along its forward and side edges to prevent tools from sliding off of the work bench;
one or more partition plates extending between the side walls and defining one or more shelves inside the tool box;
a plurality of apertures formed on the partition plates for retaining the tools;
at least one rotating partition plate extending between the side walls, the rotating partition connected by hinges to the side walls to swing upwardly from a substantially horizontal position; and
a plurality of pegs disposed on the rotating partition plate and extending upwardly.

2. The tool box of claim 1, wherein the rotating partition plate extends adjacent to the lower cover when the rotating partition plate is in a substantially horizontal position and the tool box is in a closed position.

3. The tool box of claim 1, wherein the pegs extend substantially adjacent to the lower cover when the rotating partition plate is in a substantially horizontal position and the lower cover is in a closed position such that tools disposed on the pegs are secured in position by the lower cover.

4. The tool box of claim 1 further comprising one or more upwardly extending compartments having an opening and disposed on the partition plates.

5. The tool box of claim 4, wherein the opening of the upwardly extending compartments is substantially adjacent to the upper cover when the upper cover is in a closed position so that the tools in the upwardly extending compartments are secured in place when the tool box is in a closed position.

6. The tool box of claim 4, wherein the opening of the upwardly extending compartments is substantially adjacent to the lower cover when the lower cover is in a closed position so that the tools in the upwardly extending compartments are secured in place when the tool box is in a closed position.

7. The tool box of claim 1 further comprising one or more downwardly extending compartments having an opening and attached to the partition plates.

8. The tool box of claim 7, wherein the opening of the downwardly extending compartments is substantially adjacent to the upper cover when the upper cover is in a closed position so that the tools in the downwardly extending compartments are secured in place when the tool box is in a closed position.

9. The tool box of claim 7, wherein the opening of the downwardly extending compartments is substantially adjacent to the lower cover when the lower cover is in a closed position so that the tools in the downwardly extending compartments are secured in place when the tool box is in a closed position;

10. The tool box of claim 1 further comprising one or more hanging rods each extending between one of the side walls and the downwardly extending compartment to hang the tools.

11. The tool box of claim 1 further comprising one or more hanging rods each extending between one of the side walls and the upwardly extending compartment to hang the tools.

12. The tool box of claim 1, wherein when the tool box is in a closed position the forward edges of the upper and lower covers engage to close the tool box to secure the tools in place.

13. The tool box of claim 1 further comprising a locking mechanism disposed on the upper cover for latching the upper cover to the lower cover to lock the tool box.

14. The tool box of claim 1 further comprising a locking mechanism disposed on the lower cover for latching the lower cover to the upper cover to lock the tool box.

15. The tool box of claim 1, wherein the base, the side walls, the rear walls and the covers are made of sheet metal.

16. A tool box with an integrated work bench comprising:
a base;
a pair of side walls extending upwardly from the base, each of the side walls having a rear vertical edge, an upper horizontal edge, a front vertical edge, and a slanted edge sloping downwardly from the upper horizontal edge to the front vertical edge;
a rear wall extending upwardly between the side walls, the rear wall having an upper horizontal edge;
an upper cover pivotally connected by hinges at a location adjacent to the upper section of the rear wall to pivotally swing open upwardly, the upper cover having a horizontal section and a slanted section sloping downwardly from the horizontal section;
a lower cover pivotally connected by hinges at a location adjacent to the forward edge of the base, the lower cover configured to pivotally swing open downwardly to a horizontal position to form the integrated work bench, the lower cover having an upwardly turned flange along its forward and side edges to prevent tools from sliding off of the work bench;
one or more partition plates extending between the side walls and engaging the upper and lower covers when the tool box is in a closed position, the partition plates defining one or more shelves inside the tool box;
a plurality of apertures formed on the partition plates for retaining tools;
at least one rotating partition plate extending between the side walls, the rotating partition connected by hinges to the side walls to swing upwardly from a substantially horizontal position, the rotating partition plate extending adjacent to the lower cover when the rotating partition plate is in a horizontal position and the tool box is in a closed position;
a plurality of pegs disposed on the rotating partition plate and extending upwardly, the pegs extending substantially adjacent to the lower cover when the rotating partition plate is substantially in a horizontal position and the lower cover is in a closed position such that tools disposed on the pegs are secured in position by the lower cover;
a locking mechanism disposed on the upper cover for latching the upper cover to the lower cover to lock the tool box;
one or more upwardly extending compartments having an opening and disposed on the partition plates, the opening of the upwardly extending compartments being substantially adjacent to the upper cover when the upper cover is in a closed position so that the tools in the upwardly extending compartments are secured in place when the tool box is in a closed position;
one or more downwardly extending compartments having an opening and attached to the partition plates, the opening of the downwardly extending compartments being substantially adjacent to the upper cover when the upper cover is in a closed position so that the tools in the downwardly extending compartments are secured in place when the tool box is in a closed position;
one or more hanging rods extending between the side walls and the compartments to hang the tools;
wherein, in a closed position, the forward edges of the upper and lower covers engage to close the tool box to secure the tools in place.

17. The tool box of claim 16 further comprising at least two carrying handles, each one of the carrying handles being disposed on one of the side walls for carrying the tool box.

18. The tool box of claim 16, wherein the base, the side walls, the rear wall and the covers are made of sheet metal.
